(19) United States
(12) Patent Application Publication
(10) Pub. No.: US 2002/0161657 A1
(43) Pub. Date: Oct. 31, 2002

(54) System for rapid identification of vehicle occupants for the purpose of facilitating mobile sales marketing, communication and safety

(76) Inventors: Mark A. Kojac, San Clemente, CA (US); Mark Roknich, Dana Point, CA (US); Gregory A. Powers, Dana Point, CA (US)

Correspondence Address: LEVIN & HAWES, P O BOX 4140, LAGUNA BEACH, CA, 92652

(21) Appl. No.: 09/738,804

(22) Filed: Dec. 14, 2000

(51) Int. Cl. G06F 17/30; G06F 17/60

(52) U.S. Cl. 705/26

(57) ABSTRACT

A method and apparatus for communication to a target of communication identified by a communicator is disclosed that may comprise providing an identifier that is visually observed by the communicator; including with the identifier an Internet web-site address where the communicator can obtain information about the target of the communication including a communication path to the target of the communication; and providing an ability to search databases hosted directly or indirectly at the Internet web-site to identify the target of the communication and/or a path of communication to the target of the communication based upon the identifier.

### FIELD OF THE INVENTION

This invention has application and relevance in e-commerce, e-business, personal communication, safety and law-enforcement.

### RELATED APPLICATION

This Application is related to and relies upon for priority the Provisional Patent Application filed on Dec. 14, 1999, by the above named inventors, entitled INTERNET PORTAL HAVING INFORMATION INDEXED BY LICENSE PLATE NUMBER, filed under attorney Docket Number PNATCH.001PR.

### BACKGROUND OF THE INVENTION

It is well known in the art to utilize the Internet, otherwise known as the world wide web (“www” or “the web”), for communication between people and/or entities having access to the web through any of a wide variety of web accessing devices, the number and variety of which are growing continuously. Through such access users can obtain information, including searching web-sites and various available databases of information and conduct so-called e-commerce with so-called e-businesses, through such simple mechanisms as accessing a web-site and following instructions to navigate through, e.g., a virtual catalogue, and accessing information, such as manufacturer data, pricing, shipping costs, and further actually submit real time orders for and pay for products contained in such virtual catalogues. There are also systems that allow the user once obtaining access to the web, and logging in to a known web site, e.g., one like “GoTo.com”™ along with the use of such available technology as the Global Positioning System (“GPS”) to enable the user to gather information about where the user would like to go, along with directions from where the user is, e.g., if the user is interested in obtaining a pizza, the user can request a listed pizza parlors within some selected range from the user's position that are in some fashion registered with the provider of this service or available through the access by the provider of this service to databases, e.g. so-called “Yellow Pages” listings or electronic listings of that type.

The intern has also been suggested to be useable as an electronic or virtual matchmaking or dating service, with information being accessible over the web at a web-site, e.g., based upon a license plate. “PlateDate.com” which appears to have been an attempt at such a system suggests that someone logging on to the web-site of “PlateDate.com” could leave a message for the owner of the vehicle identified by the license plate number, and the owner could in some fashion access the message left on the web site.

Another web-site, www.ratemydriving.com, appears to be a site that allows the registering of a message to be sent to a subscriber to the web-site that it receives in due time. It does not appear to allow, e.g., a viewer/user of the vehicle in question to obtain the identity of the subscriber.

There is a need, however, for a more effective and efficient way for communication of information over the internet from a user desirous of being contacted and a user who is made aware of the user desirous of being contacted and the reason that the user desires to be contacted, business, personal, professional, public safety, etc. and the identification of the place on the internet to effect that contact and/or to find out more information about the user (person or entity) desirous of being contacted and making the contact.

### SUMMARY OF THE INVENTION

A method and apparatus for communication to a target of communication identified by a communicator is disclosed that may comprise providing an identifier that is visually observed by the communicator; including with the identifier an Internet web-site address where the communicator can obtain information about the target of the communication including a communication path to the target of the communication; and providing an ability to search databases hosted directly or indirectly at the Internet web-site to identify the target of the communication and/or a path of communication to the target of the communication based upon the identifier.

### BRIEF DESCRIPTION OF THE DRAWINGS

FIG. 1 shows a schematic representation of the system of the present invention generally;

FIG. 2 shows a schematic representation of an embodiment of the present invention effecting interconnection of users over the Internet;

FIG. 3 shows a schematic representation of an embodiment of a communication network, including the Internet, useful with the present invention;

FIG. 4 shows a block diagram of an embodiment of a main site mapping according to the present invention;

FIG. 5 shows a block diagram of an embodiment of a flow chart representing the operation of a web-site in executing a variety of options for searching on a main page of an embodiment of the portal according to an embodiment of the present invention;

FIG. 6 shows a block diagram of an embodiment of a flow chart representing the operation of a vehicle match module of an embodiment of the present invention;

FIG. 7 shows a block diagram of an embodiment of a flow chart representing the operation of a business match module of an embodiment of the present invention;

FIG. 8 shows a block diagram of an embodiment of a flow diagram representing the operation of a people match module of an embodiment of the present invention;

FIG. 9 shows a schematic representation of an embodiment of the interrelation of databases, which can be utilized in accordance with the present invention;

FIG. 10 shows a license plate blank useful in an embodiment of the present invention;

FIG. 11 is a perspective view showing the positioning of a license plate blank according to FIG. 10 on the bumper of a vehicle ac cording to an embodiment of the present invention; and,

FIG. 12 a, 12 b and 12 c show license plate frames according to an embodiment of the present invention.

### DETAILED DESCRIPTION OF THE PREFERRED EMBODIMENTS

The database suite shall consist of an integrated system of 1) proprietary data accumulated by a host of, e.g., an Internet Web-site from viewer registration, membership and subscription and stored on the hosts web server's, and 2) existing databases to which the host subscribes to make the host's databases appear more robust. The host also maintains “virtual databases” for users, club and organizations, which are a partition of the host's proprietary (and licensed) data targeting the individual groups (for example the group Edsel Owner's club can be supplied functional modules on their own websites to all records in the host's vehicle match, personal match and business match database suite containing a group I.D.=“EdselOC”). This creates, by narrowing the search criteria, databases within the host's data that can be licensed or cross-marketed with subscriber groups.

These three database functions are integrated into one “portal” for seamless functionality to the end user. This entire database suite is accessible through the Internet, and offers functionality through web browsers, and through speech recognition systems (such as telephony-based stock quote services).

The database suite is further sub-characterized including these sections: VehicleMatch Section: Classified Advertising of Vehicles for Sale, and Showcasing of Vehicles Not for Sale

Viewers can search for vehicles for sale or lease through matching license plate information. Viewers may also search for inquiries to their own license plate information. Viewers can also browse and search for similar vehicles or vehicles matching other criteria.

PeopleMatch Section: Personal Listings, Clubs, Hobbies

Viewers search for people who are members of the host web-site, e.g., which can be called “PlateMatch.com,” through their license plate information. Viewers can also search for inquiries to their own license plate information. Viewers can also browse and search for similar people profiles or people matching other criteria.

BusinessMatch Section: Advertisement of Occupant's Profession Viewers can search for business and people who are members of the host's website through their license plate information. Viewers can also browse and search for similar or different businesses through categories matching viewer's interests. SafetyMatch Section: Report/Investigate Suspicious Vehicles, Erratic Driving Viewers can search for comments about their driving, make comments about the driving of others, through their license plate information as a search criteria. Parents can check on the driving habits of their children. Law enforcement agencies can have access to the database and be automatically sent, e.g., an E-mail reporting suspicious vehicles and/or erratic driving with time and location information where available.

Other functional site modules can include auctions, personalized license plate search/auction, e-commerce and online retail of related and promotional merchandise, and links to relevant sites (e.g., Kelley Blue Book).

Searching is not only the function to the site, but also posting of data is integral to creating an interesting, robust two-way medium. Consumers browsing the BusinessMatch Section, e.g., can request proposals/bids from businesses. In the same way, viewers browsing the PeopleMatch section can post their profiles for others to respond. Would be buyers can, e.g., post in the VehicleMatch section “vehicle wanted” classifieds. In the SafetyMatch Section, an observer can report erratic driving of a vehicle by license plate number to the host's web-site, and conversely, can seek a match in the database suite of previously identified suspicious vehicles (including databases provided by law enforcement agencies).

Revenue Model: Revenues are gathered through multiple sources: membership fees (“People” or personal section), advertising fees (vehicle classifieds), subscription-based advertising (business classifieds and safety), and advertising revenue collected from entities advertising to the host's end user, through banner ads, animation and video, as visual medium and audio for voice-only appliances.

Automation: By creating and installing a “macro” or “script” or “cookie” into the user's browser, computer, or telephony device, the process of accessing the database suite is a “one-touch” function. By activating a preset button, function key or screen area (on touch-sensitive devices), the user is forwarded immediately to the host's database through Internet access. Conventional methods of Internet browser applications are also used. Searching for license plate matching information is a simple one-step request.

Security/Privacy: Voice or keypad input of user information and password is required in some sections, unless the user elects for a “cookie” to be deposited on the user's access device by prior use. This system applies to both voice access, data access, and hybrid devices such as mobile phones with Internet functionality. Only after password access is granted are protected areas of database suite information communicated to a user.

Features: The database responds with voice or data results of a license plate search attempt. Should a user wish to investigate similar records in the database, search criteria are captured matching a successful “hit,” or established anew, to provide the user with multiple record matches similar to the initial inquiry. Should no successful result be provided from the search, the user will be offered “near miss” options (for example: “no license plate with that number exists in the database, but these three were found to be close to your input . . . ). Options exist in the host's database to provide for varying amounts of accuracy in license plate number search inputs (search regimes include: all digits, first of last x digits, where x=1, 2, 3, 4, 5, 6 or 7, and sequential proximity, such as “6Z8835” versus “6Z8836”). Settings for accuracy will be selectable as well as set by default by the host. Multiple users of a vehicle are provided for in all databases through an additional flag in the database suite.

Time and location information will be provided, when possible by direct user inputs to the database (keying in, making menu selections, or speaking in information into database fields), or automatically through integration with devices that provide time with devices that provide time and location automatically. Interface options and database fields are provided for time recording devices and navigational devices (such as GPS) to apply not only time and date stamps to the record, but also location stamps. This function will provide for nearly real-time tracking of a vehicle's whereabouts through query of the database suite of the host's site, e.g., platematch.com, and through automatic messaging arrangements (to law enforcement and others).

Content: Detail page templates for PeopleMatch members can be provided. VehicleMatch ads, and BusinessMatch ads will be template web-pages that will include headlines, body text, categories and features, and media-rich features: images, photographs, audio clips, multimedia, “virtual tours” and streaming and downloadable video are offered where appropriate. Multiple match results will offer thumbnail views of records, complete with images, and will offer list formats, with maximum result per page settings to facilitate faster searches and screen downloads.

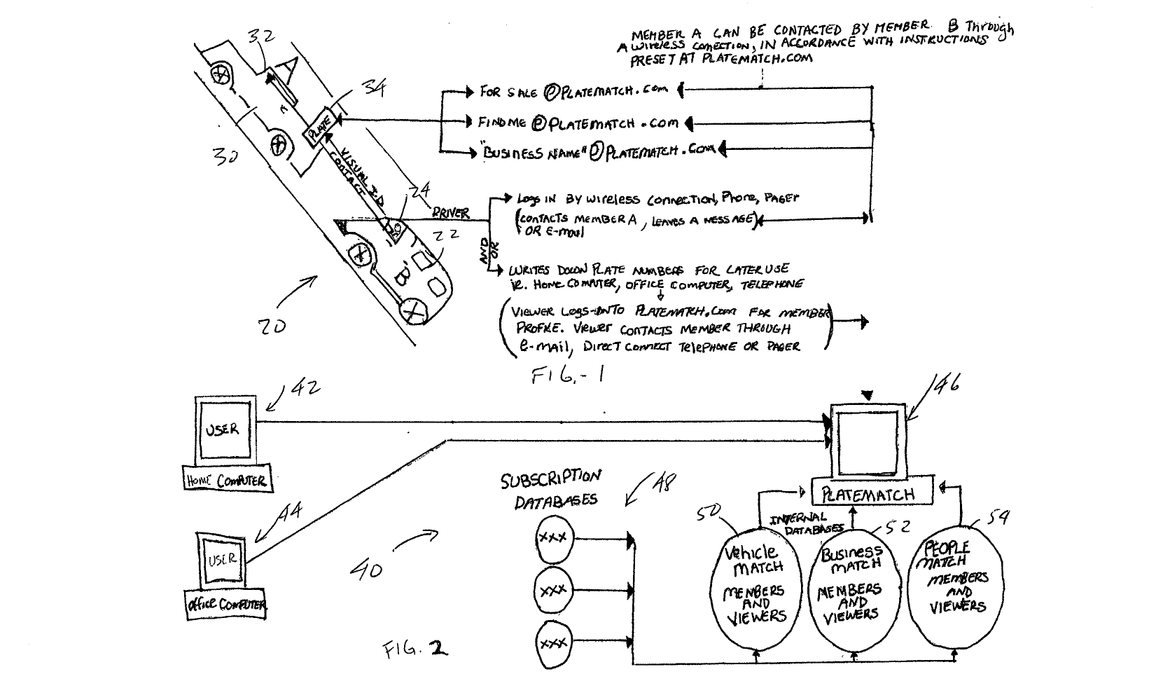

Turning now to FIG. 1 there is shown a schematic representation of the system 20 of the present invention generally. The system 20 can involve a member vehicle 30 designated vehicle A which can be driven by a member 32. The member vehicle 30 can have attached to it a member identifier, e.g., a license plate 34. It will be understood by those in the art that in those states where license plates are required on both the front and rear mounting places for such plates, other identifiers, such as license plate frames, shown in FIG.'S 12 a-c can be used. As shown in FIG. 1 the identifier may be one of a variety of indicators transmitting a message to the viewer of the identifier, e.g., a driver 24 of a vehicle 22, designated vehicle B, e.g., that the occupant/owner of the vehicle A is interested in selling the vehicle, and where the viewer, e.g., in vehicle b can find information about the vehicle being offered for sale and reach the occupant/owner of the vehicle in regard to a possible sale of the vehicle A, e.g., through the Internet and over the host's web-page, i.e., “For Sale@PlateMatch.com.” Similarly, personal match 5 communications to viewers, e.g., the viewer in vehicle B and location information may be provided, e.g., “FindMe@PlateMatch.com.” Likewise a business wishing to communicate that it can be reached over the Internet and how can display “[Business Name]”@PlateMatch.com.” Information relating to the owner/occupant of the vehicle A can be present and available on the database available at the host web-site and searchable through the host web-site at least by license plate number, including, e.g., plate number (alphanumeric, if applicable) and state of registration. Members can register to have such information placed on the Internet at the host's web-site in any of a variety of ways, e.g., through a home computer, personal assistant, lap top, palm top, messaging pager and like internet accessing devices, and can then receive, e.g., through the regular mail or other form of delivery the requisite identifiers, license plate blanks, as shown, e.g., in FIG.'s 10 and 11, license plate frames, as shown, e.g., in FIG.'s 12 a-c, or the like.

In real time, the driver of vehicle B as an example, can log on the internet, through a variety of portable internet accessing devices, palm tops, personal assistants, pagers and the like and seek to identify the owner/occupant of vehicle A. At the same time, through this connection to the Internet, the viewer occupant of, e.g., vehicle B, may be able to leave a voice message, an e-mail or other form of electronic message for the owner/occupant of the vehicle A, e.g., through the host's web-site to which the viewer logs on in response to viewing the identifier, e.g., plate 34 on the vehicle A. Real time contact with the owner/occupant of the vehicle A may also be possible, assuming that the owner/occupant is in possession of a wireless Internet accessing device and has it in operation. In such a case an e-mail or voice-mail may be communicated through the Internet connection, e.g., over the host's web-site, in real time, directly to the owner/occupant of the vehicle A. It will be understood, of course that the viewer 24 in vehicle B could in real time log onto the host's website and search for the pertinent information based upon the information contained on the indicator, e.g., plate 34 and down load this information to the viewer's portable internet accessing device or to the viewer's home or office computer and later review this information to decide whether to contact the owner/occupant registered on the host's web-site in regard to, e.g., possible purchase of the vehicle A, or meeting the owner/occupant of the vehicle A, or conducting other business with the business that owns/operates the vehicle A. Other information about the member advertising a possible contact through the portal of the host's web-site, e.g. home telephone number, or cell telephone number, may enable contact with the member other than over the Internet, including real time voice communication through, e.g., a connection over a cell phone or by other wireless telephony, including, e.g., a pager.

In addition, it can be a capability of the present system to allow the owner/occupant of the vehicle A to log on to the host web-site, e.g., through an onboard wireless connection and monitor in real time any attempts to contact the owner/occupant. For example, even if the owner/occupant does not have wireless voice connection, e.g., through wireless telephony, the owner/occupant may be able to download in real time, E-mails sent by any viewer(s) through a portable wireless Internet accessing device. Thus in essentially real time, the owner/occupant may be made aware of the interest of a viewer the owner/occupant in real time can identify and act accordingly, e.g., by initiating contact in person, or suggesting a meeting through a return message, over, e.g., wireless telephony or through the Internet.

It will also be appreciated that the owner of the vehicle A may not necessarily be the occupant of the vehicle A and could, e.g., be a parent of the occupant or the owner of a business that operates the vehicle A being driven by an occupant employee. The system can be utilized for the owner to monitor communications responsive to, e.g., the poor driving of the occupant and/or the location of the vehicle in an improper place or the route of the vehicle, or other information available due to viewer log in's relating to the vehicle.

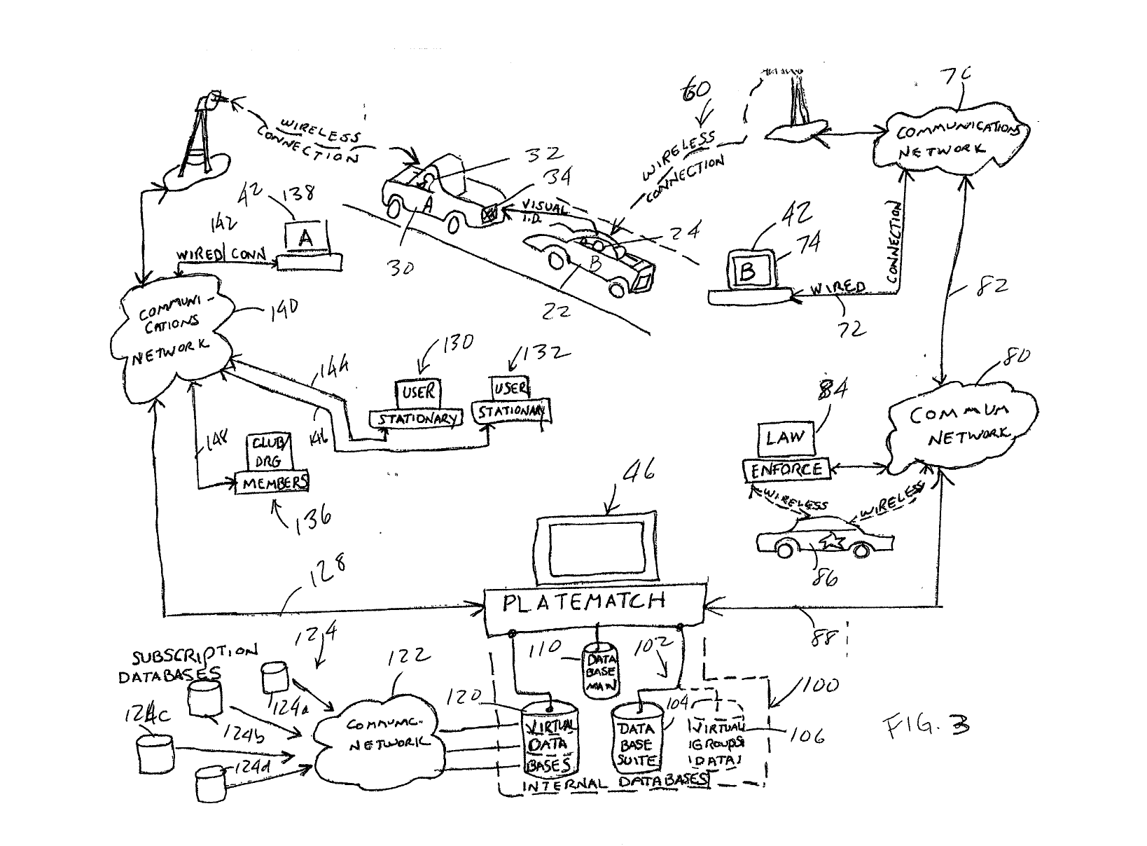

Turning now to FIG. 2 there is shown a schematic representation of an embodiment of the present invention effecting interconnection of users over the Internet. The system 40 can include a n internet accessing device, such as a home desktop computer 42 or an office desktop computer 44, in connection over the Internet with a computer 46, which may act, e.g., as a host server for the host's web-site, e.g., designated PlateMatch.com. Accessible through the host server 46 may be a variety of databases, e.g., internal hosted databases that may be segmented, e.g., into a VehicleMatch Members and viewers database segment 50, a BusinessMatch Members and Viewers database segment 52 and a PeopleMatch Members and Viewers database segment 54. Other databases may also be available such as Subscription Databases 48, including, e.g., business and personal telephone directories, to which the host may subscribe in order to allow both member and viewer or only member or viewer access, as appropriate. It will be understood that the information about viewers who log on to the host's web-site in response to viewing an identifier, e.g., the plate 34 on the vehicle A, and the fact that the identifier for the vehicle A was the prompt for such access to the web-site is also stored in the databases at or accessible through the web-site, e.g., databases 50, 52 and 53, for, e.g., subsequent access by the owner/occupant of the vehicle A for purposes of possibly contacting the viewer who logged on to the web-site and searched for the owner/occupant based upon the identifier, e.g., the plate numbers on plate 34.

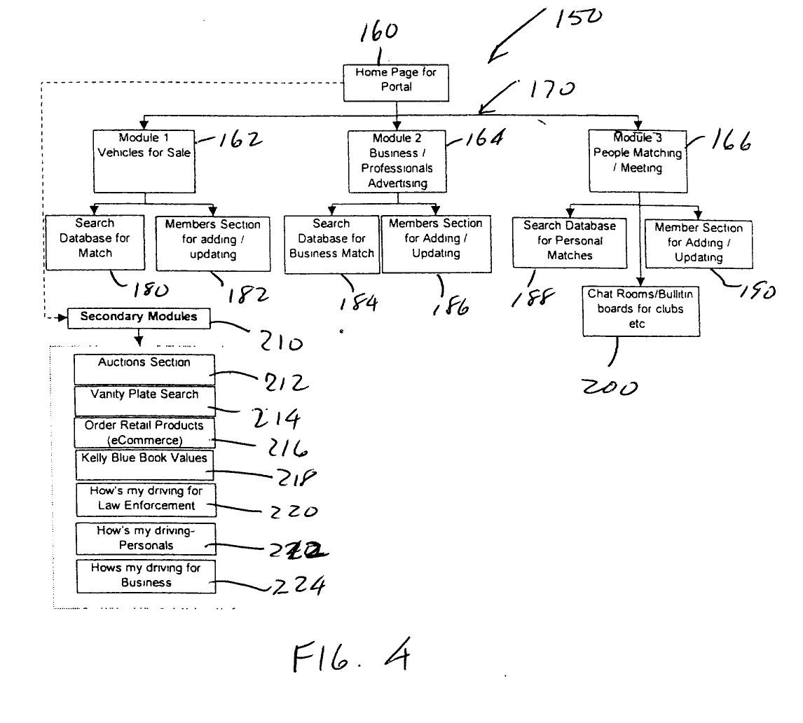

Turning now to FIG. 3, there is shown a schematic representation of an embodiment of a communication network 60, including the Internet, useful with the present invention. The network 60 can link together through wireless connections as noted above, e.g., a member, e.g., the owner/occupant in vehicle A and a viewer in vehicle B. The viewer in vehicle B may log on to the host Internet web-site server 46 through a wireless connection to the communications network 70, e.g. a completely wireless telephone system 70 or a wireless telephone system 70 that links to the Public Switched Telephone Network (“PSTN”). The viewer may also be linked through the communications network 70 to the viewer's personal computer, e.g., home desktop computer 42, through a wired connection 72, e.g., the twisted pair telephone lines coming into the home of the viewer. The communication network 70 may be connected to other portions of the communications network 80 through a link that could be wired, wireless radio frequency, microwave, etc., to which may be linked a server 84 as a part of a law enforcement computer/Internet system and/or in wireless connection with field units of law enforcement, e.g., a patrol care 86. The portion of the communications network 80 may be linked to the server 46 for the host web-site through a connection 88, which may be wired, e.g., by the twisted pair or other wired telephony lines coming into the location of the server 46. The server 46 for the host web-site may be in direct connection with internal databases 100, which may include a pair of databases 102, which may include a data base suite 104 and a virtual groups database 106, as well as a main database 110, and virtual links 120 to other subscriber databases 124 a-d through a portion of the communications network 122. The server 46 may also be linked through, e.g., a wired connection 128 to a portion 140 of the communication network. The portion 140 of the communications network may also be connected to the owner/operator of the vehicle A through a wireless connection and through a wired connection 142 to the home computer 138 of the member/owner/operator. The computers, e.g., 130, 132 of other members and/or users may be connected to the communications network, e.g., through the portion 140 by, e.g., wired connections 144 and 146, respectively. The computers of other club or organization members that may have access to the host's web-site, e.g., computer 136, may be connected to the communications network, e.g., through the portion 140 by e.g., a wired connection 148.

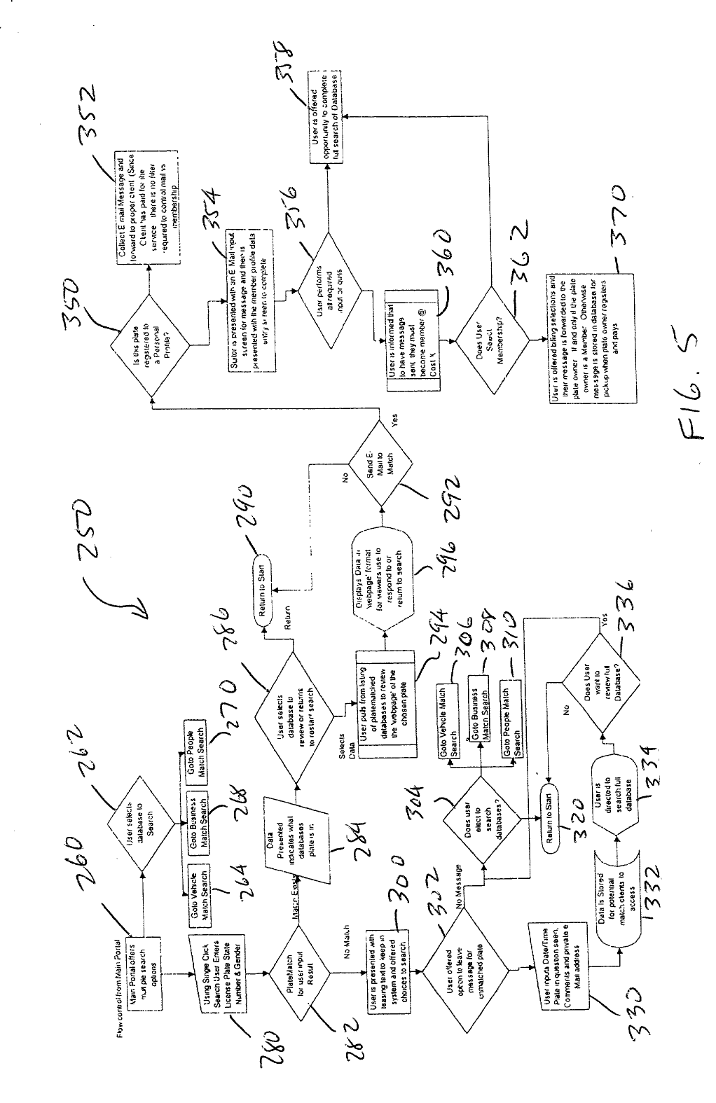

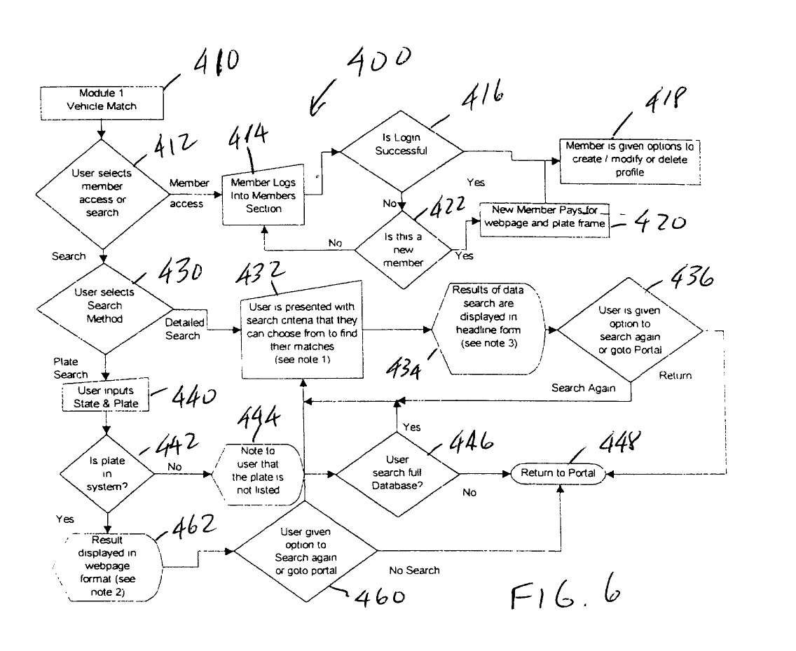

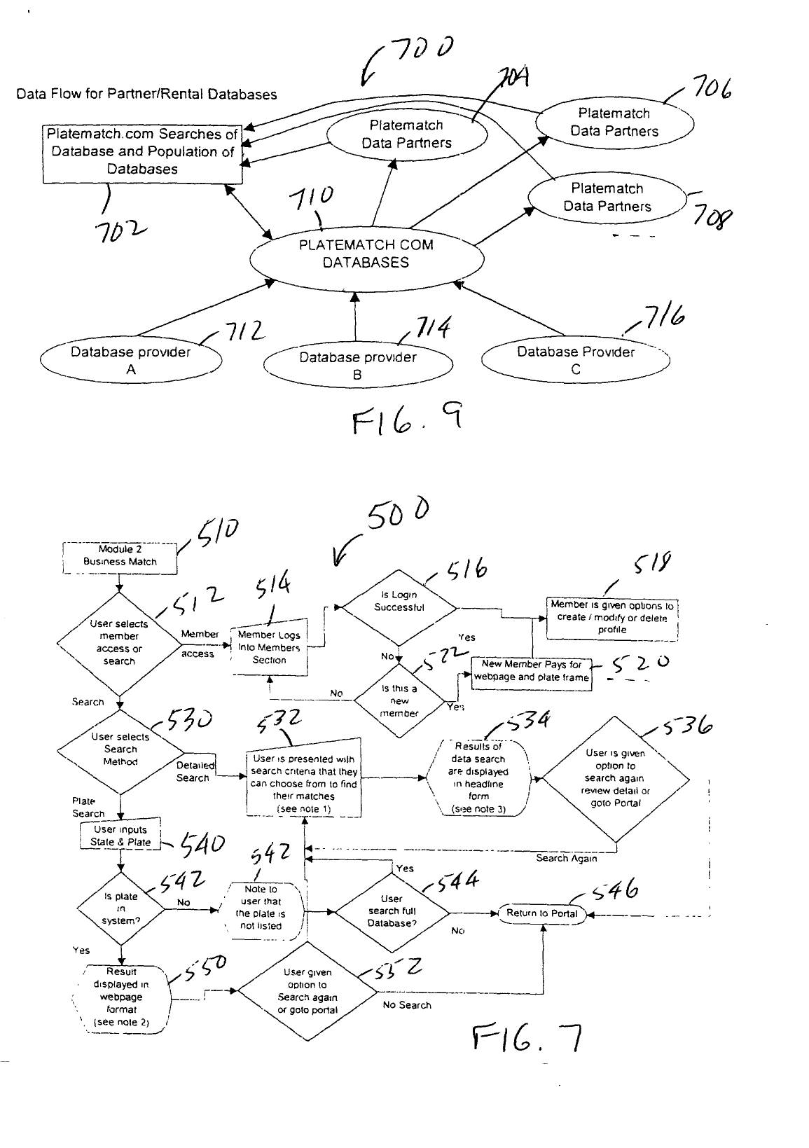

Turning now to FIG. 4, there is shown a block diagram of an embodiment of a main site mapping 150 according to the present invention. The mains site mapping 150 may include a home page 160 for the host web-site portal 150. Accessible through the home page 160 can be a series of selectable modules 170, e.g., module 162 involving vehicles for sale, module 164 involving business/professional advertising and module 166 involving people matching/meeting. Each of the modules 162, 164, 166, respectively may include a sub-module 180, 184 and 188 including some for of searching capability, e.g., utilizing one of a number of search engines/browsers to search in the respective database for the respective module 162, 164 or 166. Each of the modules 162, 164, and 166 may also include a sub-module, respectively 182, 186 and 190 that enables member/users to modify information contained in the databases concerning the member, the member's vehicle or business, and the like, by adding modifying or otherwise updating the information in the databases. Any of the modules, e.g., module 166 may also enable access to other functionalities, e.g., chat rooms, bulletin boards and the like in, e.g., sub-module 200. In addition, the home page 160 can enable access to a variety of secondary modules 210 either directly hosts on the web-site or made available in some virtual manner over the Internet. These secondary modules 210 may include, e.g., an auctions section 212, a vanity plate searching capability section 214, an link to one or more E-commerce portals 216, a specific portal, e.g., to Kelly Blue Book Values, in section 218, and a variety of specific links such as those in sections 221, 222 and 224 that provide information, respectively to law enforcement, vehicle owners and businesses regarding communications that have been received from members or viewers regarding a particularly identified vehicle and such information as its location at a given date/time, comments on its operation, reports of it being in trouble or in a suspicious location at a suspicious time, etc.

Turning now to FIG. 5 there is shown a block diagram of an embodiment of a flow chart 250 representing the operation of a web-site in executing a variety of options for searching on a main page of an embodiment of the portal according to an embodiment of the present invention. In block 260, the main page portal 160 in FIG. 4 presents to the user a number of search options through the monitoring in decision block 262 of whether the user has selected a database to search. If the user has selected a database to search, the system selects the particular database by executing a got to Vehicle match search in the vehicle match database in block 264, a go to Business Match Search to search the business match database in block 268 for business interactions or a Go to the People match Search to search the People Match database for personal interactions in block 270

The user can then enter, e.g., by clicking on numbers and letters or other selections from such things as pull-down or pop-up menus or selection boxes information pertinent to the search, e.g., the identifier number or alphanumeric code, e.g., a license plate number, and the gender of the occupant in box 280. In box 282 the system 250 makes a determination of whether or not the identifying information, e.g., the license plate number is in the database corresponding to some or all of the user input in box 280. In the event that a match does so exist, in block 284, the system in block 284 presents on the screen display the identity of which of the respective databases in which the identifier appears. At this point, the system 250 allows the user to select in block 286 whether or not to view the information contained in one or more of the respective databases in which the identifier appears or to return to block 260 to begin another search. If the latter option is selected, the system goes to the Return to Start block 290. In the event that the user selects to review the contents of the respective database, the system can allow the user in block 294 to select data to view this data, which may be organized in the form of a web-page assigned to the particular identifier in, e.g., each of the respective databases accessed, e.g., through the go to blocks 264, 268 and 260, assuming that the identifier may be registered in more than one of the databases accessed, e.g., through the go to blocks 264, 268 and/or 270. The system 250 then in block 296 can in block 296 display in web-page format for the viewer's use the information retrieved by the system from the respective database accessed through blocks 264, 268 and/or 270.

The system in block 292 can then give the user the opportunity to select a communication opportunity, e.g., to send an E-mail, e.g., to the person or 1 0 entity identified from the information displayed on block 296. In the event that the user declines to select this communication opportunity, the system can return to start through block 290.

In the event that there was no match the user can be offered, e.g., other search choices in block 300. In block 302, the user can be offered a choice of leaving an E-mail message for the unmatched identifier. It will be understood that the identifier may be unmatched because the identifier, e.g., a vehicle license plate number, is not a member of the host web-site, though, e.g., the identifier, e.g., the vehicle license plate may be available in the database, but not the link to display the web-page as occurs in block 296, or because the identifier identifies a member that does not desire such display, but does wish to anonymously receive messages left for that member per identification through the identifier. If no message is selected to be sent, the user in block 314 can be asked to choose wither to search other databases, in which event the system returns to start in block 320. In the event that the user elects to search another database, the respective go to block 306, 25 308 or 310 is executed, as was so with blocks 264, 268 and 270. In block 330, the user can input information, e.g., the date and time the user viewed, e.g., the identifier, the identifier in question and can create a communication, e.g., a private E-mail message, which the system can direct to a member desirous of receiving anonymously such messages or can store the message as in block 332 in the event that the identifier subsequently becomes registers by a member joining the host web-site at a later date. At this point the system 250 can inquire in block 334 whether the user wishes to search the full database, and if so the system returns the user to block 304 and if not the system returns to start through block 320.

In the event that the user has selected in block 292 to send an email to the identified member whose data is displayed in block 296, the system inquires as to whether the identifier, e.g., the vehicle license plate number, is registered to a personal profile in block 350. If the answer is yes, then in block 352 the system 250 will collect any pertinent E-mail messages and forward them to the member, e.g., who has chosen to receive e-mails anonymously. If the answer to the inquiry in block 350 is no, then the user can be presented, e.g., with an E-mail input screen in box 354 for the creation of messaging to the member and may be presented with a member's profile data to complete, along with the message. The system in block 356 can then determine whether the appropriate entries have been made and if so, in box 360 may inform the user, e.g., on a screen display, that the user needs to register as a member to forward the E-mails. This function can, of course be optional, and E-mails can be sent by the system, wither or not the user registers as a member. In box 362, assuming this functionality is included, the user may be asked to select or not select joining as a member. In the event that the user elects to join as a member, in block 370 the user can be given certain information, e.g., choices for billing and the user's E-mail will be sent to the existing member identified by the identifier, e.g., the vehicle license plate. If the user has not completed all of the entries required in block 354 or does not elect to join as a member in block 362, then the user is given the opportunity to complete a full search of the databases in block 358.

A possible way to search that may result in certain advantages can include entering the state, vehicle license plate number and possibly the gender of the occupant of the vehicle having this identifier and querying all merged databases to return all potential matches. If a viable match is produced, the user can go directly to details of the member, e.g., by being logged on to the member's web-page. This can save the user from having to drill down through the respective databases or having to interpret and determine where to search to find the member in which database, etc.

Turning now to FIG. 6 there is shown a block diagram of an embodiment of a flow chart 400 representing the operation of a vehicle match module 162 as shown in FIG. 4, of an embodiment of the present invention. The module 162 flow diagram 400 has a starting block 410. In block 412 the user is asked to select between search access and member access. If the user selects member access, in block 414 the member is given a screen display that enables login to the Members Section portion of the database. In block 416, the system determines if log in was successful and if not it determines in block 422 whether or not this is a new member logging in. If it is determined that it is not a new member logging in then the system returns to block 414. If it is determined that it is a new member logging in block 422, the system in block 420 presents the user with information for selecting a manner of payment for the member's web-page and the physical identifier, e.g., a license plate blank or license plate frame. Subsequently in block 418, the user can be given the option to and access to input screen data entry facilities, e.g., input boxes, to create and/or modify or delete profile information stored in or to be stored in the database.

In the event that the search option is selected in box 412, the system can give the user the opportunity in box 430 to select between a detailed search and an identifier, e.g., vehicle plate, search. If the user selects an identifier search, in box 440 the user can be given the opportunity to input an identifier, e.g., the state and number of a vehicle license plate. In box 442, the system determines whether the identifier, e.g., the vehicle license plate number and state matches an identifier in the database. In the event that a match occurs, the system in box 462 displays the information about the identified member, e.g., by calling up the member's webpage. It will be understood that match criteria, as noted above can be selected and/or elected which are other than a perfect match and the system will return the information and screen displays and web-pages, as appropriate for each of the matches which, though not exact, meet the selected or elected criteria.

In the event that the identifier is not matched in block 442, the system displays an indication that the identifier is not matched in block 444 and thereafter the user is given the opportunity in block 446 to select to search the full database or to return to the module portal through block 448. Similarly after the matching result(s) is displayed in block 462 the user can select to do a full search or return to the module 162 portal 410, through the block 448.

In block 432, accessed from respective blocks 430, 446 and 460 the user can be presented with search criteria, which may be selectively utilized, some or all, to search the database. These criteria may include, e.g., a vehicle license plate, the type of vehicle (car, truck, boat, motorcycle, recreational vehicle, etc.) the make of the vehicle, the model of the vehicle, the engine size of the vehicle, the color of the vehicle, the location of the vehicle, e.g., at a given time, the type to vehicle drive, e.g., 2 or 4 wheel, whether there is a photo available, whether the vehicle is offered privately or by a dealer, the miles on the vehicle and the price of the vehicle. In block 434 the system can display the results of the search, e.g., including a headline for the vehicle(s) recovered in the search, a photo of each vehicle so recovered, a virtual tour of such vehicle or video of such vehicle, text descriptions of the vehicle and information about the vehicle, links to the member's E-mail or personal or business web-site, telephone numbers of the member, and a listing of the search criteria selected by the user for the respective search. It will be understood, that various search engines are available that can selectively weight certain search criteria and/or select matches that do not meet all of the search criteria but do meet some selected percentage or weighted percentage according to how the system is set up, in making the selection from the database of an appropriate match(s). The headline format for display of the search results may be in a single line format showing basic information about the matched item, e.g., vehicle, along with a “headline field”, price, photos, miles make and model, etc. The year of production, geographic location of the vehicle and any other items of useful information that are in the databases can also be displayed. In block 436 the user is given the opportunity to select another search, thereby having the system return the user to block 432 of to return to the portal through block 448.

Turning now to FIG. 7 there is shown a block diagram of an embodiment of a flow chart 500 representing the operation of a business match module of an embodiment of the present invention. This flow diagram is essentially identical to that in FIG. 6, with the exception that the search criteria applicable her in block 532 may be slightly different and may include, e.g., a vehicle license plat number and state, the type of business or trade identified on the vehicle or by the identifier (painter, plumber, real estate agent, etc.), a sub-category of business (e.g., commercial painter), a geographic location of the business, hours of operation, etc. In addition, the detailed display of information about the member, e.g., a web-page for the member, in block 550 of FIG. 7 may include such information as the member name, a marketing headline, a geographic location, hours of operation, contact methods, as well as the types of information noted above in regard to FIG. 6. Further, the display in block 534 may include a marketing tag for the business of the member as well as geographic location information and the type and subtype of business, along with the name of the business of the member.

Turning now to FIG. 8 there is shown a block diagram of an embodiment of a flow diagram 600 representing the operation of a people match module of an embodiment of the present invention. This module, like that of FIG. 7 is essentially identical to that of FIG. 6 with a few exceptions. A block 656 is inserted between the block 654, corresponding to the block 444 in FIG. 6, and the block 658, which corresponds to the block 446 in FIG. 6. In block 656, the user may be given an opportunity to select whether or not to leave a message for the member identified by the identifier, e.g., the vehicle license plate. If the user elects not to leave a message, then the selection to search the full database is given in block 658. If the user elects to leave a message, then in block 664 in FIG. 8, the user can be presented with an input screen, which may include inputs such as data and time, the identifier, e.g., the vehicle plate number, a message text and a return E-mail address. And subsequent to such entries, the system takes the user to the return to portal block 648 corresponding to the similar block 448 in FIG. 6. In addition, the search criteria presented to the user in block 642, corresponding to the similar block 432 in FIG. 6, may include in addition to those items listed above with respect to block 432, gender, age, geographic location, occupation, physical characteristics, e.g., body build, height, weight, etc., personal habits, such as smoking, drinking, drug use, the existence of children, type of relationship being sought, group affiliations or hobbies, religion, the presence of a photo and marital status, among other personal information data. The results of the search displayed in block 660, corresponding to the similar block 462 in FIG. 6, may include a headline or “teaser” for the individual member, photos of the member, video, textual material describing information about the member and their interests and desires, links to personal E-mail or personal web-sites along with the search criteria employed. Also, the display in block 644, corresponding to the similar display in block 434 in FIG. 6, may include the headline format of the search results showing basis information about the member person including a “headline field”, photos, geographic location, age and name and any other items that the member may wish to be displayed.

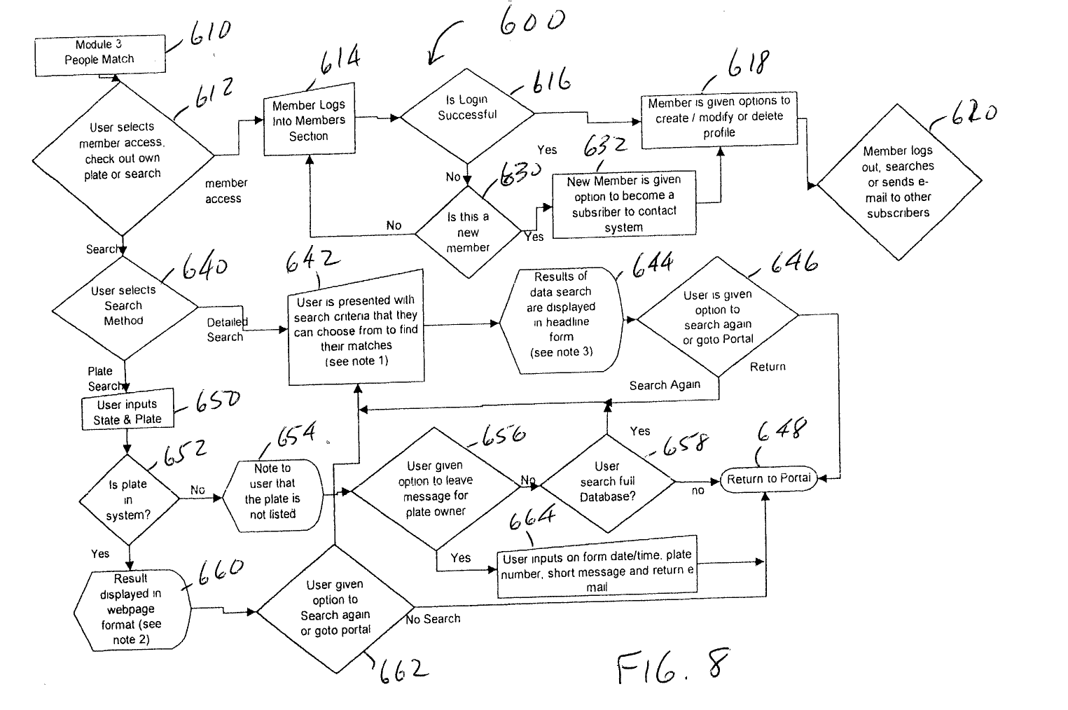

Turning now to FIG. 9 there is shown a schematic representation of an embodiment of the interrelation of databases, which can utilized in accordance with the present invention. In this schematic block diagram is shown that the access to databases, e.g., through the modules described in regard to FIG.'s 6-8, represented by block 702 can tie into the main host databases 710 connected directly to the host server (46 in FIG. 3). The content of the main databases 710 can be supplemented through addition of databases, e.g., 712, 714 and 716 provided respectively by database providers A, B and C, e.g., “excite classified 2000” via, e.g., physical downloads or via queries, creating in effect virtual databases for member or users to search. Data partners 704, 706 and 708 for the host web-site may be provided, e.g., access into the host databases and virtual databases depending upon the demographics and other criteria established by the host and agreed upon with the host data partners, 704, 706 and 708. These host data partners may also contribute to the host databases through the interface provided by the modules 702 with the host retaining control of the information input and the revenues provided to the data partners, 704, 706 and 708.

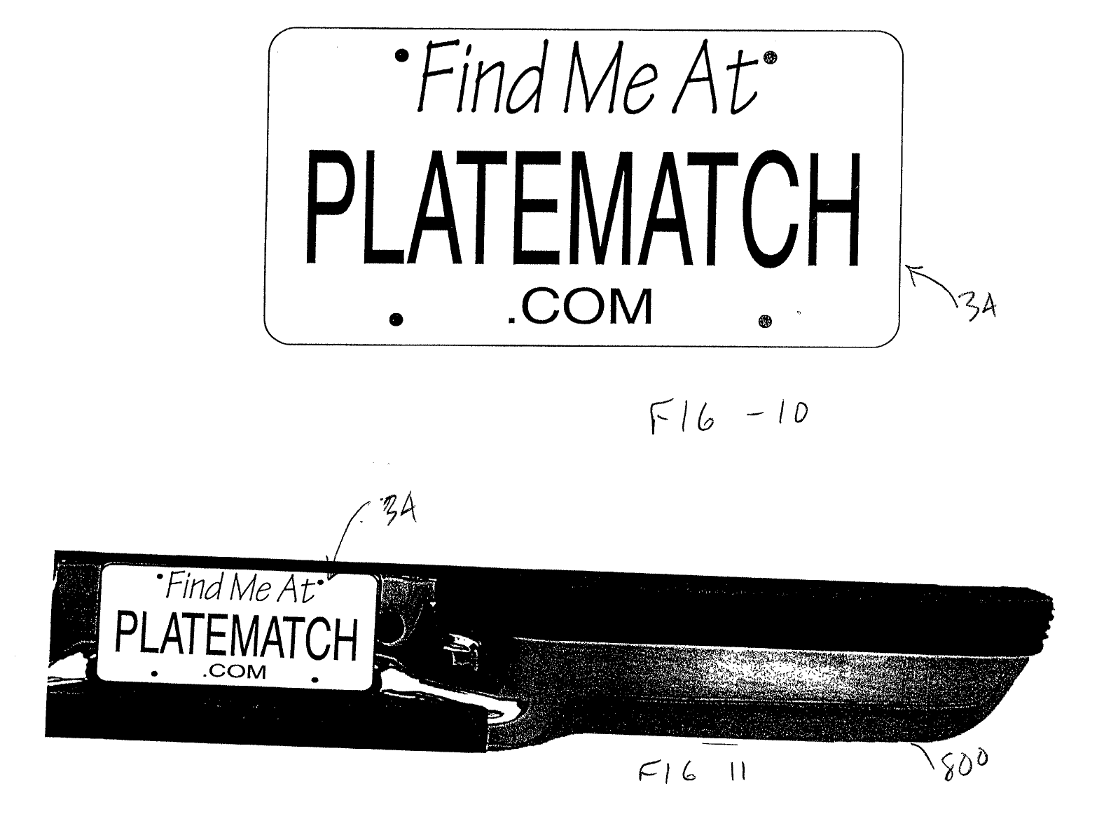

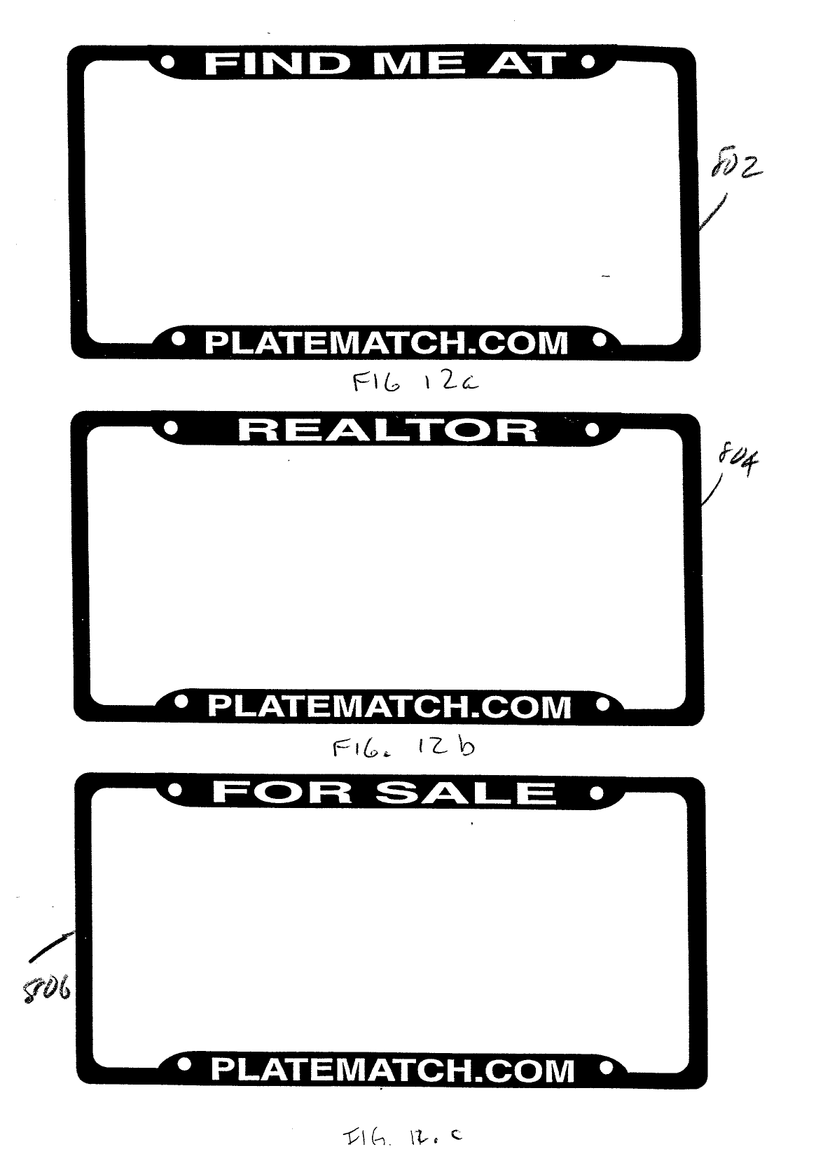

Turning now to FIG. 10 there is shown an identifier, e.g., a vehicle license plate blank 34 useful in an embodiment of the present invention. The illustrated identifier can indicate that the displayer of the identifier can be contacted through the personal or “Find Me” database at the host web-site, e.g., PlateMatch.com.

Turning now to FIG. 11 there is shown a perspective view showing the positioning of an identifier, e.g., a license plate 34 on the bumper 800 of a vehicle.

Turning now to FIG.'S 12 a, 12 b and 12 c there are shown, respectively identifiers consisting of license plate frames 802, 804 and 806, according to an embodiment of the present invention. These license plate frames 802, 804 and 806, respectively can be for identification of the member as being found in the personal or “Find Me” database section on the host web-site, the business section or the vehicle sale section.

In operation, the system of the present invention may employ a voice activated portal, whereby through a phone access to the portal after some identification of the caller, e.g., through conventional userID systems or through some password or other code, incorporating, e.g., voice, keypad entry, or voice print confirmation, or the like, access to the databases may be had, to e.g., check one's own records, messages (text and voice) and data, or to leave data, messages (text and voice), or to perform a search of the database, e.g., to locate and connect to another member or to an identified viewer/user. The member can, e.g., speak the member's plate number and state, or other identifier, as a login or filter, speak a license plate number and or other identifier of the target of the search, and connect to data stored in the database indexed by that identifier. This can enable, e.g., the following exemplary operations, the viewer/user driving behind a member, and visually detecting the identifier, e.g., the vehicle license plate, by number and state, can call PlateMatch.com via, e.g., a wireless telephony connection (or wired if from a stationary position), e.g., through a URL identifier access, and, e.g., by speaking the identifier, or some satisfactory portion of it, a viewer/user can be connected to the member, including, e.g., to the member's cell phone or another wireless or wired phone number that the member has specified in the host Database for the direction of such contacts from viewer/users of the system, or can be directed to leave a message, voice or text, in the host database, or on the member's own answering matching accessed by a telephone number extracted from the databases by the system, as explained above in response to the member being located as a result of the search in the databases for the respective identifier. This can enable, as noted above, real-time inter-vehicle communication through the identifier on the one vehicle as the means of identification of the owner/occupant/member desirous of being contacted. It can also as noted above result in such communication with the owner who may not be the occupant of the vehicle, but, e.g., the parent or business owner, manager or the like. All of these multiple functions are integrated within, facilitate by and/or enabled by the host portal and connection of, e.g., the viewer user to the host portal, as noted through, e.g., URL connection or voice connection or the like.

Another aspect of the present invention is the ability for its users to search a database, indexed by a license plate number, or other familiar type of identifier, to facilitate the following functions: integration of a variety of functions into one interface (the host's, e.g., PlateMatch.com's Directory), whereby a search yields a list indexed by the plate number(s), or other identifier(s), discovered in the search, producing links in that listing, with each link directing the viewer to potentially a different function (driver rating, vehicle ad, personals ad, message box, business classified, etc. The “integration” of these communication functions and categories, integration provides benefits over prior art searching mechanisms and methods.

The present invention has been described with respect to preferred embodiments. It will be understood by those skilled in the art that many variations and modification of the disclosed preferred embodiments may be made without changing or departing from the scope and spirit of the present invention, e.g., other identifiers may be used, including those instances where, e.g., the business desirous of being contacted is identified by a plaque or sign at the business, as opposed to a vehicle license plate, which in that event may have a code to identify the business, in the same way as a license plate number, which may include, e.g., simply the name of the business of some part thereof or abbreviation thereof. The messaging described in some detail in the modules of FIG.'s 6-8 can be substituted for by other forms of real time of subsequent communication by such means as wireless telephony, pagers, personal contact or the like. Therefore the present invention is described and claimed through the following claims:

We claim:

1. A method for communication to a target of communication identified by a communicator, comprising the steps of:
providing an identifier that is visually observed by the communicator;
including with the identifier an Internet web-site address where the communicator can obtain information about the target of the communication including a communication path to the target of the communication; and,
providing an ability to search databases hosted directly or indirectly at the Internet web-site to identify the target of the communication and/or a path of communication to the target of the communication, based upon the identifier.

2. A communication device for communication by a communicator to a target of the communication, comprising:
an identifier connected to the target of the communication so as to be visually observable by the communicator;
the identifier including an Internet web-site address where the communicator can obtain information about the target of the communication including a communication path to the target of the communication; and,
an Interned web-site adapted to enable searching of databases hosted directly or indirectly at the Internet web-site to identify the target of the communication and/or a path of communication to the target of the communication, based upon the identifier.
